(19) United States
(12) Patent Application Publication
(10) Pub. No.: US 2026/0170727 A1
(43) Pub. Date: Jun. 18, 2026

(54) TEMPLATE GENERATION METHOD, APPARATUS, DEVICE, MEDIUM, AND PRODUCT

(71) Applicant: Beijing Zitiao Network Technology Co., Ltd., Beijing (CN)

(72) Inventors: Xiao LI, Beijing (CN); Zhi YE, Beijing (CN); Xueyu SONG, Beijing (CN)

(21) Appl. No.: 19/340,828

(22) Filed: Sep. 25, 2025

(30) Foreign Application Priority Data
Dec. 16, 2024 (CN) 202411855756.4

(51) Int. Cl. G06T 11/60

(52) U.S. Cl. CPC G06T 11/60

(57) ABSTRACT

The present disclosure provides a template generation method and apparatus, a device, a medium, and a product. The method includes: acquiring an original multimedia material and a layout image, where the layout image is configured to indicate an area in which a foreground object cannot be generated; determining description information of the original multimedia material according to the original multimedia material, where the description information is configured to describe multimedia content of the original multimedia material; and inputting the description information of the original multimedia material and the layout image into an image generation model to obtain a template image output by the image generation model, where the template image includes a background picture, a foreground object, and a placeholder area, and the placeholder area corresponds to the area in which the foreground object cannot be generated indicated by the layout image.

### CROSS-REFERENCE TO RELATED APPLICATIONS

This application claims priority to Chinese Patent Application No. 202411855756.4, filed on Dec. 16, 2024, which is incorporated herein by reference in its entirety.

### TECHNICAL FIELD

The present disclosure relates to the field of computer technologies, and in particular, to a template generation method, an apparatus, an electronic device, a computer-readable storage medium, and a computer program product.

### BACKGROUND

In scenarios such as advertisement delivery and poster promotion, an original multimedia material is packaged to highlight characteristics of the original multimedia material for targeted advertisement delivery or poster promotion. In general, a template is used for packaging the original multimedia material.

### SUMMARY

The present disclosure provides a template generation method, an apparatus, an electronic device, a computer-readable storage medium, and a computer program product corresponding to the above method.

According to a first aspect, the present disclosure provides a template generation method. The method includes:
acquiring an original multimedia material and acquiring a layout image, where the layout image is configured to indicate an area in which a foreground object cannot be generated;
determining description information of the original multimedia material according to the original multimedia material, where the description information is configured to describe multimedia content of the original multimedia material;
inputting the description information of the original multimedia material and the layout image into an image generation model to obtain a template image output by the image generation model, where the template image includes a background picture, a foreground object, and a placeholder area, and the placeholder area corresponds to the area in which the foreground object cannot be generated indicated by the layout image.

According to a second aspect, the present disclosure provides a template generation apparatus. The apparatus includes:
an acquiring module, configured to acquire an original multimedia material and acquire a layout image, where the layout image is configured to indicate an area in which a foreground object cannot be generated;
a determining module, configured to determine description information of the original multimedia material according to the original multimedia material, where the description information is configured to describe multimedia content of the original multimedia material;
a generating module, configured to input the description information of the original multimedia material and the layout image into an image generation model to obtain a template image output by the image generation model, where the template image includes a background picture, a foreground object, and a placeholder area, and the placeholder area corresponds to the area in which the foreground object cannot be generated indicated by the layout image.

According to a third aspect, the present disclosure provides an electronic device. The electronic device includes a processor and a memory. The processor and the memory communicate with each other. The processor is configured to execute instructions stored in the memory to cause the electronic device to perform the template generation method according to the first aspect or any implementation of the first aspect.

According to a fourth aspect, the present disclosure provides a computer-readable storage medium. Instructions are stored in the computer-readable storage medium, and the instructions instruct an electronic device to perform the template generation method according to the first aspect or any implementation of the first aspect.

According to a fifth aspect, the present disclosure provides a computer program product including instructions. When the computer program product runs on an electronic device, the electronic device is caused to perform the template generation method according to the first aspect or any implementation of the first aspect.

In the present disclosure, on the basis of the implementations provided in the above aspects, further combination may be performed to provide more implementations.

### BRIEF DESCRIPTION OF THE DRAWINGS

In order to more clearly illustrate the technical methods in the embodiments of the present disclosure, the drawings required to be used in the embodiments will be briefly introduced below.

FIG. 1 is a schematic flowchart of a template generation method provided by some embodiments of the present disclosure;

FIG. 2 is a schematic diagram of a layout image provided by some embodiments of the present disclosure;

FIG. 3 is a schematic diagram of a layout image provided by some embodiments of the present disclosure;

FIG. 4 is a schematic structural diagram of an image generation model provided by some embodiments of the present disclosure;

FIG. 5 is a schematic structural diagram of a template generation apparatus provided by some embodiments of the present disclosure; and

FIG. 6 is a schematic structural diagram of an electronic device provided by some embodiments of the present disclosure.

### DETAILED DESCRIPTION

In the embodiments of the present disclosure, the terms “first” and “second” are only used for descriptive purposes, and cannot be understood as indicating or implying relative importance or implicitly indicating the number of indicated technical features. Therefore, the features defined as “first” and “second” may explicitly or implicitly include one or more features.

Firstly, some technical terms and application scenarios involved in the embodiments of the present disclosure are introduced.

In scenarios such as advertisement delivery and poster promotion, an original multimedia material is packaged to highlight characteristics of the original multimedia material for targeted advertisement delivery or poster promotion. Considering the efficiency of packaging the original multimedia material, in general, a template image is generated in advance, and the original multimedia material and corresponding copy are added to the template image to complete the packaging of the original multimedia material.

In the related art, since advertisement content or poster content formed after the original multimedia material is packaged usually includes a background picture and a foreground object, in the process of automatically generating a template, the background picture and the foreground object are usually generated separately, and then the background picture and the foreground object are combined based on a layout rule to generate a template image.

However, in the related art, the generated template image is low in quality and poor in flexibility. For example, the above method has the following problems: firstly, the correlation between the template image and the original multimedia material is low, and the template image is difficult to reflect the multimedia content of the original multimedia material; moreover, the background picture and the foreground object are generated separately and are not related to each other, resulting in a low overall aesthetics of the template image; in addition, after the layout rule or business scenario changes, the layout rule needs to be re-established, and the controllability of the template image is poor and the richness is limited, making it difficult to realize flexible template generation.

In view of this, the present disclosure provides a template generation method. In the method, an original multimedia material is acquired, and a layout image is acquired, where the layout image is configured to indicate an area in which a foreground object cannot be generated; description information of the original multimedia material is determined according to the original multimedia material, where the description information is configured to describe multimedia content of the original multimedia material; the description information of the original multimedia material and the layout image are input into an image generation model to obtain a template image output by the image generation model, where the template image includes a background picture, a foreground object, and a placeholder area, and the placeholder area corresponds to the area in which the foreground object cannot be generated indicated by the layout image.

In the method, the image generation model is used to realize automatic generation of the template image. Since inputs of the image generation model include the description information of the original multimedia material and the layout image, on the one hand, the generated template image is strongly related to the multimedia content of the original multimedia material, thus enhancing the correlation between the template image and the original multimedia material; on the other hand, the background picture and the foreground object are generated concurrently, thus enhancing the integrity of the template image. Moreover, the area of the foreground object in the template image meets the layout requirements of users, and diversified template images may be generated quickly and flexibly for different original multimedia materials.

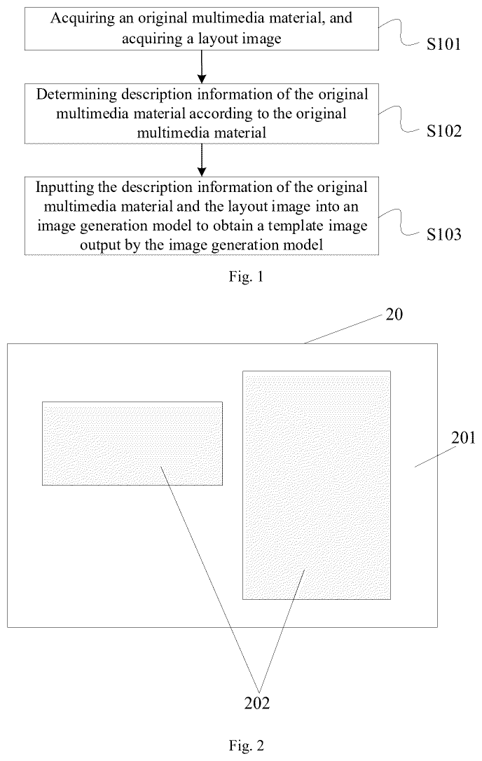

In order to facilitate understanding of the technical solutions provided in the embodiments of the present disclosure, the following will be described in conjunction with the drawings. Referring to the schematic flowchart of a template generation method shown in FIG. 1, for example, the method includes the following steps.

S101: acquiring an original multimedia material, and acquiring a layout image.

The original multimedia material may be understood as a multimedia material to be packaged. In other words, after the template image is generated by using the template generation method provided by some embodiments of the present disclosure, the template image may be configured to package the original multimedia material.

In the embodiments of the present disclosure, the source of the original multimedia material is not limited. For example, the original multimedia material may be a multimedia material stored locally, or the original multimedia material may also be a multimedia material uploaded to a cloud for storage.

In the embodiments of the present disclosure, the type of the original multimedia material is not limited. For example, the original multimedia material may be a video material, an audio material, a picture-text material, etc.

The layout image may be understood as an image configured to indicate a layout of the template image. In general, the template image may include a background picture and a foreground object, and in the embodiments of the present disclosure, the layout image may be configured to indicate an area in which the foreground object cannot be generated.

That is, a user (for example, a business party with a template generation requirement) only needs to provide the layout image configured to indicate an expected layout position of the template image, and does not need to provide information for describing a specific position, a shape, a color, etc. of the background picture or the foreground object.

In the embodiments of the present disclosure, the source of the layout image is not limited. For example, the layout image may come from a pre-made template image, and the template image is parsed to obtain a plurality of layout images, and the user may select a required layout image from the plurality of layout images. For another example, the user may also design the layout image in combination with an actual image generation requirement.

S102: determining description information of the original multimedia material according to the original multimedia material.

The description information may be configured to describe multimedia content of the original multimedia material. In the embodiments of the present disclosure, the description information of the original multimedia material may be described in a natural language to represent natural language content, that is, the description information of the original multimedia material may describe the multimedia content of the original multimedia material in the form of the natural language.

S103: inputting the description information of the original multimedia material and the layout image into an image generation model to obtain a template image output by the image generation model.

The image generation model may be understood as a model for generating an image based on text, that is, the image generation model has the ability to generate an image based on text. At the same time, the image generation model also has the ability to perform control on a layout position of the generated image, that is, the image generation model may control a position in the generated image of an element (for example, the foreground object) in the generated image. In the embodiments of the present disclosure, the type of the image generation model is not limited, for example, the image generation model may be a diffusion model.

For example, the template image output by the image generation model may include a background picture, a foreground object, and a placeholder area. The background picture may be understood as a picture used as a background in the template image, and a size of the background picture may be the same as that of the template image. The foreground object may be understood as an object other than the background picture in the template image. The foreground object may be located above the background picture, and there may be a plurality of foreground objects. In an advertisement delivery or poster promotion scenario, the foreground object may be a sticker, a decoration, a search box, an organization logo, etc.

The placeholder area may be understood as an area used for placing other elements other than the foreground object. For example, the placeholder area may be configured to place the original multimedia material or copy content, that is, in the template image, the placeholder area cannot be configured to place the foreground object.

In the embodiments of the present disclosure, the placeholder area corresponds to the area in which the foreground object cannot be generated indicated by the layout image. In other words, the template image output by the image generation model meets the image generation requirement indicated by the layout image, realizing that the position of the foreground object in the template image is controllable.

In the method, the image generation model is used to realize automatic generation of the template image. Since inputs of the image generation model include the description information of the original multimedia material and the layout image, on the one hand, the generated template image is strongly related to the multimedia content of the original multimedia material, thus enhancing the correlation between the template image and the original multimedia material; on the other hand, the background picture and the foreground object are generated concurrently, thus enhancing the integrity of the template image. Moreover, the area of the foreground object in the template image meets the layout requirements of users, and diversified template images may be generated quickly and flexibly for different original multimedia materials.

The template generation method provided by the embodiments of the present disclosure is introduced above, and the following describes the exemplary content in the template generation process.

In the embodiments of the present disclosure, the image generation model is informed of an image generation requirement of an expected template image through the layout image. In some embodiments, the layout image may include a first area carrying a first identifier and a second area carrying a non-first identifier, the first area is an area in which the foreground object can be generated, and the second area is an area in which the foreground object cannot be generated.

The identifier may be understood as a feature capable of identifying an area, and the first identifier is not limited in the embodiments of the present disclosure. For example, the first identifier may be a first color, a first texture, a first grayscale, etc.

Description is made by taking an example in which the first identifier is the first color. As shown in FIG. 2, a layout image 20 includes a first area 201 of the first color (white) and a second area 202 of a non-first color (gray), the first area 201 is an area in which the foreground object can be generated, and the second area 202 is an area in which the foreground object cannot be generated. That is, the second area 202 may be configured to indicate the placeholder area.

In this way, different areas are distinguished by different identifiers in the layout image, so that the image generation model learns the area in which the foreground object can be generated and the area in which the foreground object cannot be generated through the identifiers of each area in the layout image, and then generates the foreground object in the area in which the foreground object can be generated, does not generate the foreground object in the area in which the foreground object cannot be generated, and the placeholder area in the output template image corresponds to the second area in the layout image.

In the embodiments of the present disclosure, the layout image is only configured to inform the image generation model of the area in which the foreground object cannot be generated, and the specific position of the foreground object is not limited. In this way, the image generation model may freely generate the template image, and the specific position, contour, style, pattern, etc. of the foreground object are not limited.

The template generation method provided by the embodiments of the present disclosure may be applied to scenarios such as advertisement delivery and poster promotion, and in the above scenarios, advertisement content or poster content formed after the original multimedia material is packaged may include copy content. Therefore, the layout image may be configured to indicate an area configured to place the multimedia material and an area configured to place the copy content.

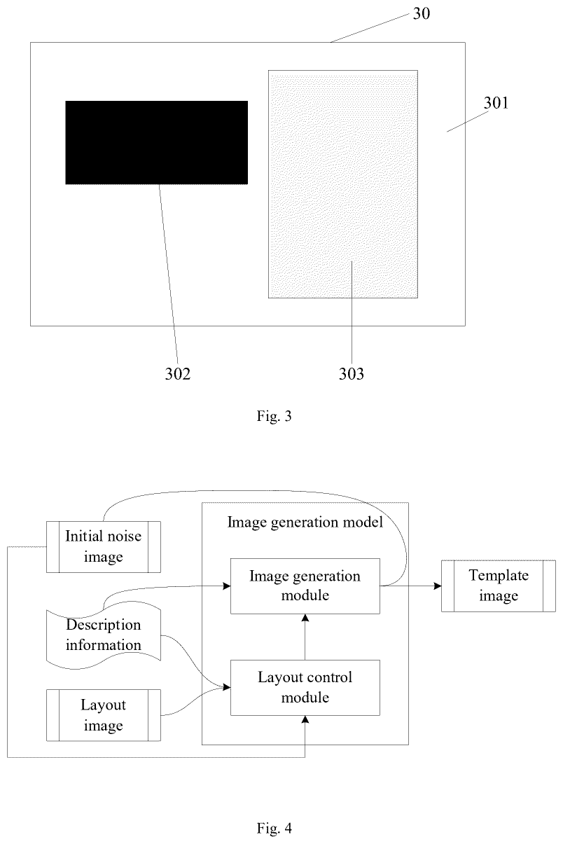

Similarly, the area configured to place the multimedia material and the area configured to place the copy content may be distinguished by an identifier. Description is made by taking an example in which the identifier is color. As shown in FIG. 3, a layout image 30 includes a first area 301 of a first color (white) and a second area of a non-first color (black and gray), the first area 301 is an area in which the foreground object can be generated, and the second area is an area in which the foreground object cannot be generated. The second area is exemplarily divided into an area 302 (black area) configured to place the copy content and an area 303 (gray area) configured to place the multimedia material.

That is, the area configured to indicate that the foreground object cannot be generated in the layout image may be exemplarily divided into the area configured to place the multimedia material and the area configured to place the copy content. It may be understood that since the area configured to place the multimedia material needs to place the original multimedia material, the foreground object cannot be generated. Since the area configured to place the copy content needs to place the copy content, the foreground object cannot be generated.

In this case, after the template image is generated by using the image generation model, the placeholder area in the template image may include a third area and a fourth area, the third area corresponds to the area configured to place the multimedia material indicated by the layout image, and the fourth area corresponds to the area configured to place the copy content indicated by the layout image.

In this way, in scenarios such as advertisement delivery and poster promotion, the area configured to place the multimedia material and the area configured to place the copy content are respectively configured in the layout image, so as to reserve positions for the original multimedia material and the copy content, thereby facilitating subsequent efficient packaging of the original multimedia material.

The following describes the exemplary process of determining the description information of the original multimedia material. In some possible implementations, the description information of the original multimedia material is determined by means of a model. For example, a first prompt is generated, the first prompt is sent to a first model, and the description information of the original multimedia material returned by the first model is received.

The first model may be a model capable of extracting the description information of the original multimedia material. For example, the first model may be a multimodal model. The multimodal model is an artificial intelligence (AI) model with multimodal information (such as text information, image information, audio information, video information, etc.) processing capability.

The first model has natural language processing ability, and may understand meaning of a natural language and process different types of natural language tasks. In the embodiments of the present disclosure, the first model determines the description information of the original multimedia material based on a prompt learning method. A prompt may be configured to guide the first model to perform specific output in a generative task (such as a text generation task, a question answering task, a dialogue task). By configuring the prompt, the first model may understand background and requirements of the task, and the first model may be enabled to process different types of natural language processing tasks without re-training the first model, thereby increasing expandability and flexibility of the first model.

In the embodiments of the present disclosure, the first prompt may include the original multimedia material and content indicating a generation of the description information of the original multimedia material. Since the first prompt includes the above information, the first model may analyze the original multimedia material based on the prompting ability of the first prompt, and output the description information of the original multimedia material.

In some embodiments, an enrichment processing may also be performed on the description information to enhance the reasoning performance of the subsequent image generation model. During exemplary implementation, initial description information of the original multimedia material is determined according to the original multimedia material, and the enrichment processing is performed on the initial description information of the original multimedia material to obtain the description information of the original multimedia material.

The enrichment processing includes at least one of the following processing: splitting the initial description information into information describing a background of the original multimedia material and information describing a foreground of the original multimedia material, adding information configured to represent a multimedia style to the initial description information, and rewriting the initial description information.

That is, the enrichment processing may be understood as a process of modifying and optimizing the initial description information of the original multimedia material. In the embodiments of the present disclosure, the enrichment processing may include a plurality of different types of processing. The initial description information is split into the information describing the background of the original multimedia material and the information describing the foreground of the original multimedia material, so that the description information of the original multimedia material may describe the original multimedia material in a hierarchical and logical manner, making it more structured. The information configured to represent the multimedia style is added to the initial description information, so that the description information of the original multimedia material may represent the multimedia style, and the generated template image is similar in style to the original multimedia material, thus enhancing the correlation between the template image and the original multimedia material. The initial description information is rewritten to add disturbance to the description information of the original multimedia material. For example, the initial description information of the original multimedia material is “a puppy in yellow clothes is basking in the sun on the beach”, and after the initial description information of the original multimedia material is rewritten, the description information of the original multimedia material is “a kitten with a gray hat and a flowered shirt is skating in the square”. In this way, the generated template image has more details and the diversity of the template image is enhanced.

In some possible implementations, the enrichment processing on the initial description information of the original multimedia material may be implemented by means of a model. For example, a second prompt is generated, the second prompt is sent to a second model, and the description information of the original multimedia material returned by the second model is received.

The second model may be a model capable of performing enrichment processing on the initial description information. For example, the second model may be a multimodal model or a language model. The second model has natural language processing ability, and may understand meaning of a natural language and process different types of natural language tasks. In the embodiments of the present disclosure, the second model may perform enrichment processing on the initial description information of the original multimedia material based on a prompt learning method, and the second prompt includes the initial description information of the original multimedia material and content indicating enrichment processing on the initial description information. Since the second prompt includes the above information, the second model may analyze the initial description information of the original multimedia material based on the prompting ability of the second prompt, enrich the initial description information of the original multimedia material, and output the enriched description information of the original multimedia material. In this way, automatic enrichment processing on the description information is realized, and the reasoning effect of the image generation model is optimized.

In the embodiments of the present disclosure, the first model and the second model are not limited. For example, the first model and the second model may be the same model or different models. The first model and the second model may be multimodal models.

After the template image is output by the image generation model, the template image may also be used to make target content. For example, the original multimedia material is placed in the placeholder area of the template image to generate the target content.

The target content in different business scenarios may be different. For example, in the advertisement delivery scenario, the target content may be the advertisement content, and in the poster promotion scenario, the target content may be the poster content. The original multimedia material is added on the basis of the template image to realize the packaging of the original multimedia material.

In some embodiments, considering that in the advertisement delivery or poster promotion scenario, the advertisement content or the poster content formed after the original multimedia material is packaged may include the copy content, the placeholder area of the template image may include the third area and the fourth area. In this case, the copy content related to the original multimedia material may also be determined according to the original multimedia material.

In some possible implementations, the candidate copy content is generated from a plurality of dimensions. For example, the candidate copy content may include original title content of the original multimedia material, title content extracted from comments of the original multimedia material, title content extracted from a multimedia summary of the original multimedia material, etc. The candidate copy content from the plurality of dimensions is scored, for example, a plurality of pieces of candidate copy content are scored by using an existing scoring model, and according to the scores of the plurality of pieces of candidate copy content, the candidate copy content with the highest score is selected as the copy content related to the original multimedia material.

In this way, the generated copy content is related to the original multimedia material, and the original multimedia material is placed in the third area, and the copy content related to the original multimedia material is placed in the fourth area to generate the target content, thereby further realizing targeted packaging of the original multimedia material.

In the embodiments of the present disclosure, the effect of the template image may also be improved by adjusting the layer where the foreground object is located. For example, the foreground object in the template image is determined, and the foreground object is configured in a top layer in the template image.

That is, the foreground object in the template image is identified, and the foreground object is configured in the top layer of the entire template image. In this way, in scenarios such as advertisement delivery or poster promotion, in the advertisement content or the poster content formed after the original multimedia material is packaged, the foreground object may be displayed above the original multimedia material, achieving the floating effect of the foreground object (for example, a sticker), thereby improving the effect of advertisement delivery or poster promotion.

In the embodiments of the present disclosure, the manner of determining the foreground object in the template image is not limited. For example, an existing segmentation model may be used to perform segmentation processing on the template image to extract the foreground object in the template image.

As mentioned above, in the embodiments of the present disclosure, the template image is generated by using the image generation model, and the following describes the training process of the image generation model.

The image generation model is obtained by training as follows: acquiring training data, using description information of a training image and a layout image of the training image as inputs of an initial image generation model, using the training image as a label, and training the initial image generation model to enable the initial image generation model to generate an output image matching the description information of the training image and the layout image of the training image, to obtain the image generation model.

The training data may be understood as data for training the image generation model, and the training data may include the training image, the description information of the training image, and the layout image of the training image. The layout image of the training image may be configured to indicate an area in the training image without a foreground object.

The training of the image generation model may be supervised training, and the label may be understood as a correct output result in the supervised training. During exemplary implementation, the description information of the training image and the layout image of the training image are input into the initial image generation model, and the initial image generation model generates the output image matching the description information of the training image and the layout image of the training image, where image content of the output image is associated with the description information of the training image, and a placeholder area included in the output image corresponds to the area in the training image without the foreground object indicated in the layout image of the training image.

Then, a loss function value is calculated according to the output image of the initial image generation model and the training image used as the label, and the loss function value may represent a difference degree between the output image of the initial image generation model and the training image. Model parameters of the initial image generation model are adjusted to minimize the loss function value, thus completing one round of training process for the initial image generation model.

The above steps are repeated to perform a plurality of rounds of training processes, and the training image in each round of training process is different. In response to the difference degree between the output image of the initial image generation model and the training image meets a training end condition, the training of the initial image generation model is ended, and the image generation model capable of generating the background picture and the foreground object together and controlling the position of the foreground object is obtained.

In some embodiments, considering that the image generation model needs to generate the template image and control the position of the foreground object, the image generation model may include an image generation module and a layout control module. As shown in FIG. 4, the layout control module is configured to control a layout of the foreground object in the image, inputs of the layout control module include an initial noise image, the description information, and the layout image, and an output of the layout control module is a layout control feature. The image generation module is configured to generate an image, inputs of the image generation module include the initial noise image, the description information, and the layout control feature, and an output of the image generation module is the template image.

The initial noise image may be understood as an image composed of initial noise (for example, a random number). In general, the initial noise image has the same size as the layout image and the template image, and the image generation module may use the initial noise image as a reference to generate the template image on the basis of the initial noise image. In this way, the layout control module may extract the layout control feature on the basis of the initial noise image in combination with the description information and the layout image, thereby increasing the controllability of the template image. The image generation module may generate the template image that meets the description information and the layout control feature on the basis of the initial noise image in combination with the description information and the layout control feature, thereby realizing image generation.

It should be noted that the image generation model may include more modules on the basis of including the image generation module and the layout control module. For example, the image generation model may also include a variational autoencoder module, and the variational autoencoder module includes an encoder and a decoder, the encoder is configured to down-sample the initial noise image (for example, compressing a 512×512 initial noise image into a 16×16 image), and the decoder is configured to up-sample the image output by the image generation module (for example, restoring a 16×16 image output by the image generation module into a 512×512 template image).

The template generation method provided by the embodiments of the present disclosure is described above in detail in conjunction with FIG. 1 to FIG. 4, and the apparatus and the device provided by the embodiments of the present disclosure will be described below in conjunction with the drawings.

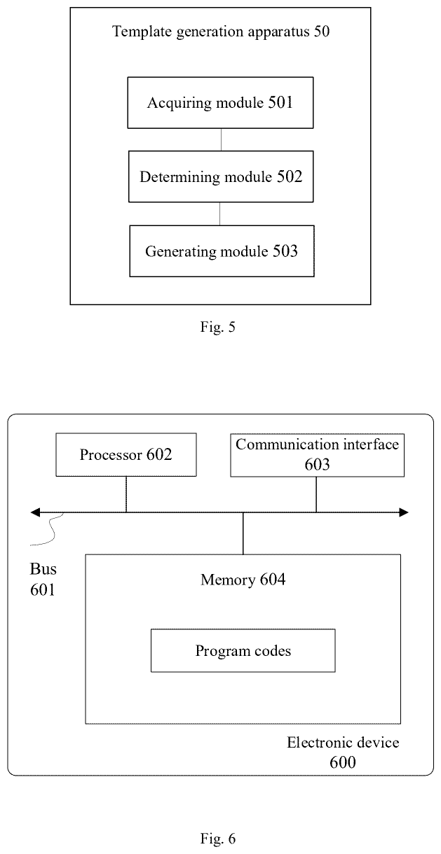

Referring to the schematic structural diagram of a template generation apparatus shown in FIG. 5, the apparatus 50 includes:
an acquiring module 501, configured to acquire an original multimedia material and acquire a layout image, where the layout image is configured to indicate an area in which a foreground object cannot be generated;
a determining module 502, configured to determine description information of the original multimedia material according to the original multimedia material, where the description information is configured to describe multimedia content of the original multimedia material;
a generating module 503, configured to input the description information of the original multimedia material and the layout image into an image generation model to obtain a template image output by the image generation model, where the template image includes a background picture, a foreground object, and a placeholder area, and the placeholder area corresponds to the area in which the foreground object cannot be generated indicated by the layout image.

In some possible implementations, the layout image includes a first area carrying a first identifier and a second area carrying a non-first identifier, the first area is an area in which the foreground object can be generated, and the second area is the area in which the foreground object cannot be generated.

In some possible implementations, the layout image is configured to indicate an area configured to place a multimedia material and an area configured to place copy content, the placeholder area in the template image includes a third area and a fourth area, the third area corresponds to the area configured to place the multimedia material indicated by the layout image, and the fourth area corresponds to the area configured to place the copy content indicated by the layout image.

In some possible implementations, the determining module 502 is exemplarily configured to:
generate a first prompt, where the first prompt includes the original multimedia material and content indicating a generation of the description information of the original multimedia material;
send the first prompt to a first model, and receive the description information of the original multimedia material returned by the first model.

In some possible implementations, the determining module 502 is exemplarily configured to:
determine initial description information of the original multimedia material according to the original multimedia material;
perform an enrichment processing on the initial description information of the original multimedia material to obtain the description information of the original multimedia material, where the enrichment processing includes at least one of the following processing: splitting the initial description information into information describing a background of the original multimedia material and information describing a foreground of the original multimedia material; adding information configured to represent a multimedia style to the initial description information; and rewriting the initial description information.

In some possible implementations, the determining module 502 is exemplarily configured to:
generate a second prompt, where the second prompt includes the initial description information of the original multimedia material and content indicating the enrichment processing on the initial description information;
send the second prompt to a second model, and receive the description information of the original multimedia material returned by the second model.

In some possible implementations, the apparatus 50 further includes a configuration module, and the configuration module is configured to:
determine the foreground object in the template image;
configure the foreground object in a top layer in the template image.

In some possible implementations, the generating module 503 is further configured to:
place the original multimedia material in the placeholder area of the template image to generate target content.

In some possible implementations, the placeholder area of the template image includes a third area and a fourth area, and the determining module 502 is further configured to:
determine copy content related to the original multimedia material according to the original multimedia material;
the generating module 503 is exemplarily configured to:
place the original multimedia material in the third area, and place the copy content related to the original multimedia material in the fourth area to generate the target content.

In some possible implementations, the image generation model is obtained by training as follows:
acquiring training data, where the training data includes a training image, description information of the training image, and a layout image of the training image, and the layout image of the training image is configured to indicate an area in the training image without the foreground object;
using the description information of the training image and the layout image of the training image as inputs of an initial image generation model, using the training image as a label, and training the initial image generation model to enable the initial image generation model to generate an output image matching the description information of the training image and the layout image of the training image, to obtain the image generation model, where image content of the output image is associated with the description information of the training image, and a placeholder area included in the output image corresponds to the area in the training image without the foreground object indicated in the layout image of the training image.

The template generation apparatus 50 according to the embodiments of the present disclosure may correspond to performing the methods described in the embodiments of the present disclosure, and the above and other operations and/or functions of each module/unit of the template generation apparatus 50 are respectively intended to implement corresponding procedures of each method in the embodiment shown in FIG. 1, which will not be repeated herein for the sake of brevity.

The embodiments of the present disclosure further provide an electronic device. The electronic device is exemplarily configured to realize the functions of the template generation apparatus 50 in the embodiment shown in FIG. 5.

FIG. 6 provides a schematic structural diagram of an electronic device 600. As shown in FIG. 6, the electronic device 600 includes a bus 601, a processor 602, a communication interface 603, and a memory 604. The processor 602, the memory 604, and the communication interface 603 communicate through the bus 601.

The bus 601 may be a peripheral component interconnect (PCI) bus, an extended industry standard architecture (EISA) bus, etc. The bus may be divided into an address bus, a data bus, a control bus, etc. For ease of representation, only one thick line is used to represent in FIG. 6, but it does not mean that there is only one bus or one type of bus.

The processor 602 may be any one or more of a central processing unit (CPU), a graphics processing unit (GPU), a micro-processor (MP), a digital signal processor (DSP), etc.

The communication interface 603 is configured for external communication. For example, the communication interface 603 may be configured to communicate with a terminal.

The memory 604 may include a volatile memory, such as a random access memory (RAM). The memory 604 may also include a non-volatile memory, such as a read-only memory (ROM), a flash memory, a hard disk drive (HDD) or a solid state drive (SSD).

The memory 604 stores executable codes, and the processor 602 executes the executable codes to perform the above template generation methods.

For example, in the case of implementing the embodiment shown in FIG. 5, and in the case that each module or unit of the template generation apparatus 50 described in the embodiment of FIG. 5 is implemented by software, software or program codes required to perform the functions of each module/unit in FIG. 5 may be partially or completely stored in the memory 604. The processor 602 executes the program codes corresponding to each unit stored in the memory 604 to perform the above template generation methods.

The embodiments of the present disclosure further provide a computer-readable storage medium. The computer-readable storage medium may be any available medium that may be stored by a computing device, or a data storage device, such as a data center, that includes one or more available media. The available medium may be a magnetic medium (for example, a floppy disk, a hard disk, a magnetic tape), an optical medium (for example, a DVD), a semiconductor medium (for example, a solid state disk), etc. The computer-readable storage medium includes instructions, and the instructions instruct the computing device to perform the above template generation methods applied to the template generation apparatus 50.

The embodiments of the present disclosure further provide a computer program product, and the computer program product includes one or more computer instructions. When the computer instructions are loaded and executed on a computing device, all or part of the processes or functions according to the embodiments of the present disclosure are generated.

The computer instructions may be stored in a computer-readable storage medium, or may be transmitted from one computer-readable storage medium to another computer-readable storage medium. For example, the computer instructions may be transmitted from one website, computer or data center to another website, computer or data center in a wired (for example, a coaxial cable, an optical fiber, a digital subscriber line (DSL)) or wireless (for example, infrared, radio, microwave, etc.) manner.

When the computer program product is executed by a computer, the computer executes any one of the above template generation methods. The computer program product may be a software installation package, and in the case that any one of the above template generation methods needs to be used, the computer program product may be downloaded and executed on the computer.

The flowcharts and block diagrams in the drawings illustrate the possibly implemented architectures, functions, and operations of the system, the method, and the computer program product according to various embodiments of the present disclosure. Each block in the flowchart or block diagram may represent a module, program segment, or part of code, and the module, program segment, or part of code includes one or more executable instructions configured to implement the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by software or by hardware. The name of the unit/module does not constitute a limitation on the unit itself under certain circumstances.

The functions described above herein may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the embodiments of the present disclosure, a machine-readable medium may be a tangible medium that may include or store programs for use by or in combination with an instruction execution system, apparatus or device. The machine-readable medium may be a machine-readable signal medium or a machine-readable storage medium. The machine-readable medium includes, but is not limited to, an electronic, magnetic, optical, electromagnetic, infrared, or semiconductor system, apparatus or device, or any suitable combination of the foregoing. More exemplary examples of the machine-readable storage medium include an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

It should be noted that the embodiments in this specification are described in a progressive manner, and each embodiment focuses on the differences from other embodiments. For the same and similar parts between the embodiments, reference may be made to each other. For the system or apparatus disclosed in the embodiments, since it corresponds to the method disclosed in the embodiments, the description is relatively simple, and for the relevant parts, reference may be made to the description of the method.

It should be understood that in the present disclosure, “at least one item” refers to one or more, and “a plurality of” refers to two or more. “And/or” describes an association relationship between associated objects, and represents that three relationships may exist. For example, “A and/or B” may represent the following three cases: only A exists, only B exists, and both A and B exist, where A and B may be singular or plural. The character “/” generally indicates an “or” relationship between the associated objects. “At least one of the following items (pieces)” or a similar expression thereof refers to any combination of these items, including a single item (piece) or any combination of a plurality of items (pieces). For example, at least one of a, b, or c may represent: a, b, c, “a and b”, “a and c”, “b and c”, or “a, b, and c”, where a, b, and c may be singular or plural.

It should also be noted that relational terms herein such as first and second are only used to distinguish one entity or operation from another entity or operation, and do not necessarily require or imply any actual relationship or order between these entities or operations. Moreover, the terms “include” or any other variation thereof are intended to cover non-exclusive inclusion, so that a process, method, object, or device that includes a list of elements includes not only those elements, but also other elements not explicitly listed or elements inherent to such a process, method, object, or device. Without further restrictions, an element defined by the phrase “including a” does not exclude the existence of other identical elements in the process, method, object, or device that includes the element.

The steps of the method or algorithm described in conjunction with the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or a storage medium of any other form known in the art.

The above description of the disclosed embodiments enables those skilled in the art to implement or use the present disclosure. Various modifications to these embodiments will be readily apparent to those skilled in the art, and the generic principles defined herein may be implemented in other embodiments without departing from the spirit or scope of the present disclosure. Therefore, the present disclosure will not be limited to the embodiments shown herein, but is to be accorded the widest scope consistent with the principles and novel features disclosed herein.

What is claimed is:

1. A template generation method, comprising:
acquiring an original multimedia material, and acquiring a layout image, wherein the layout image is configured to indicate an area in which a foreground object cannot be generated;
determining description information of the original multimedia material according to the original multimedia material, wherein the description information is configured to describe multimedia content of the original multimedia material; and
inputting the description information of the original multimedia material and the layout image into an image generation model to obtain a template image output by the image generation model, wherein the template image comprises a background picture, a foreground object, and a placeholder area, and the placeholder area corresponds to the area in which the foreground object cannot be generated indicated by the layout image.

2. The template generation method of claim 1, wherein the layout image comprises a first area carrying a first identifier and a second area carrying a non-first identifier, the first area is an area in which the foreground object can be generated, and the second area is the area in which the foreground object cannot be generated.

3. The template generation method of claim 1, wherein the layout image is configured to indicate an area configured to place a multimedia material and an area configured to place copy content, the placeholder area in the template image comprises a third area and a fourth area, the third area corresponds to the area configured to place the multimedia material indicated by the layout image, and the fourth area corresponds to the area configured to place the copy content indicated by the layout image.

4. The template generation method of claim 1, wherein the determining the description information of the original multimedia material according to the original multimedia material comprises:
generating a first prompt, wherein the first prompt comprises the original multimedia material and content indicating a generation of the description information of the original multimedia material; and
sending the first prompt to a first model, and receiving the description information of the original multimedia material returned by the first model.

5. The template generation method of claim 1, wherein the determining the description information of the original multimedia material according to the original multimedia material comprises:
determining initial description information of the original multimedia material according to the original multimedia material; and
performing an enrichment processing on the initial description information of the original multimedia material to obtain the description information of the original multimedia material, wherein the enrichment processing comprises at least one of the following processing: splitting the initial description information into information describing a background of the original multimedia material and information describing a foreground of the original multimedia material; adding information configured to represent a multimedia style to the initial description information; and rewriting the initial description information.

6. The template generation method of claim 5, wherein the performing the enrichment processing on the initial description information of the original multimedia material to obtain the description information of the original multimedia material comprises:
generating a second prompt, wherein the second prompt comprises the initial description information of the original multimedia material and content indicating the enrichment processing on the initial description information; and
sending the second prompt to a second model, and receiving the description information of the original multimedia material returned by the second model.

7. The template generation method of claim 1, further comprising:
determining the foreground object in the template image; and
configuring the foreground object in a top layer in the template image.

8. The template generation method of claim 1, further comprising:
placing the original multimedia material in the placeholder area of the template image to generate target content.

9. The template generation method of claim 8, wherein the placeholder area of the template image comprises a third area and a fourth area, and the method further comprises:
determining copy content related to the original multimedia material according to the original multimedia material; and
the placing the original multimedia material in the placeholder area of the template image to generate the target content comprises:
placing the original multimedia material in the third area, and placing the copy content related to the original multimedia material in the fourth area to generate the target content.

10. The template generation method of claim 1, wherein the image generation model is obtained by training as follows:
acquiring training data, wherein the training data comprises a training image, description information of the training image, and a layout image of the training image, and the layout image of the training image is configured to indicate an area in the training image without the foreground object; and
using the description information of the training image and the layout image of the training image as inputs of an initial image generation model, using the training image as a label, and training the initial image generation model to enable the initial image generation model to generate an output image matching the description information of the training image and the layout image of the training image, to obtain the image generation model, wherein image content of the output image is associated with the description information of the training image, and a placeholder area comprised in the output image corresponds to the area in the training image without the foreground object indicated in the layout image of the training image.

11. An electronic device, comprising a processor and a memory,
wherein the processor is configured to execute instructions stored in the memory to enable the electronic device to perform a method comprising:
acquiring an original multimedia material, and acquiring a layout image, wherein the layout image is configured to indicate an area in which a foreground object cannot be generated;
determining description information of the original multimedia material according to the original multimedia material, wherein the description information is configured to describe multimedia content of the original multimedia material; and
inputting the description information of the original multimedia material and the layout image into an image generation model to obtain a template image output by the image generation model, wherein the template image comprises a background picture, a foreground object, and a placeholder area, and the placeholder area corresponds to the area in which the foreground object cannot be generated indicated by the layout image.

12. The electronic device of claim 11, wherein the layout image comprises a first area carrying a first identifier and a second area carrying a non-first identifier, the first area is an area in which the foreground object can be generated, and the second area is the area in which the foreground object cannot be generated.

13. The electronic device of claim 11, wherein the layout image is configured to indicate an area configured to place a multimedia material and an area configured to place copy content, the placeholder area in the template image comprises a third area and a fourth area, the third area corresponds to the area configured to place the multimedia material indicated by the layout image, and the fourth area corresponds to the area configured to place the copy content indicated by the layout image.

14. The electronic device of claim 11, wherein the processor is configured to execute following steps:
generate a first prompt, wherein the first prompt comprises the original multimedia material and content indicating a generation of the description information of the original multimedia material; and
send the first prompt to a first model, and receiving the description information of the original multimedia material returned by the first model.

15. The electronic device of claim 11, wherein the processor is configured to execute following steps:
determine initial description information of the original multimedia material according to the original multimedia material; and
perform an enrichment processing on the initial description information of the original multimedia material to obtain the description information of the original multimedia material, wherein the enrichment processing comprises at least one of the following processing: splitting the initial description information into information describing a background of the original multimedia material and information describing a foreground of the original multimedia material; adding information configured to represent a multimedia style to the initial description information; and rewriting the initial description information.

16. The electronic device of claim 15, wherein the processor is configured to execute following steps:
generate a second prompt, wherein the second prompt comprises the initial description information of the original multimedia material and content indicating the enrichment processing on the initial description information; and
send the second prompt to a second model, and receiving the description information of the original multimedia material returned by the second model.

17. The electronic device of claim 11, wherein the processor is configured to execute following steps:
determine the foreground object in the template image; and
configure the foreground object in a top layer in the template image.

18. The electronic device of claim 11, wherein the processor is configured to execute a following step:
place the original multimedia material in the placeholder area of the template image to generate target content.

19. The electronic device of claim 18, wherein the placeholder area of the template image comprises a third area and a fourth area, and the processor is configured to execute following steps:
determine copy content related to the original multimedia material according to the original multimedia material; and
place the original multimedia material in the third area, and placing the copy content related to the original multimedia material in the fourth area to generate the target content.

20. A non-transitory computer-readable storage medium, comprising instructions to instruct an electronic device to perform a method comprising:
acquiring an original multimedia material, and acquiring a layout image, wherein the layout image is configured to indicate an area in which a foreground object cannot be generated;
determining description information of the original multimedia material according to the original multimedia material, wherein the description information is configured to describe multimedia content of the original multimedia material; and
inputting the description information of the original multimedia material and the layout image into an image generation model to obtain a template image output by the image generation model, wherein the template image comprises a background picture, a foreground object, and a placeholder area, and the placeholder area corresponds to the area in which the foreground object cannot be generated indicated by the layout image.
